(19) United States
(12) Patent Application Publication
(10) Pub. No.: US 2007/0131028 A1
(43) Pub. Date: Jun. 14, 2007

(54) Method for determining the vertical acceleration and the device for its implementation

(76) Inventors: Michael Naumov, Ramat Gan (IL); George Naumov, Ramat Gan (IL)

Correspondence Address: Michael Naumov, 3 Hazor st., Tel Aviv, 69 016, IL

(21) Appl. No.: 11/330,744

(22) Filed: Jan. 13, 2006

(30) Foreign Application Priority Data
Dec. 11, 2005 (IL) 172489

(51) Int. Cl. G01P 15/00

(52) U.S. Cl. 73/488

(57) ABSTRACT

The method for determining the vertical acceleration is based on the determination of the pressures difference in particular points, wherein the pressures created by the vertical acceleration are considered to be different and, the ones created by the cross accelerations are considered to be equal. According to the method there are provided the miniature devices intended for realizing the said solution. The two of these devices comprise two-vessel and one-vessel ones. One of the two-vessel devices and one-vessel device have only one sensitive element of pressure, which is considered to eliminate any harmful influence of the parameters spread of the sensitive elements of pressure. The pressure sensors of the said devices are to be switched to the differential scheme, at the output thereof the signal of the vertical acceleration is taken. The technical solution in hand is expected to eliminate any harmful influence of the disturbing factors, particularly, cross accelerations. The device as disclosed by the invention enables it to determine not only the vertical acceleration but also through changing the position of fixing it is possible to determine the horizontal acceleration, with the merits and features mentioned kept

### FIELD OF ART

The invention refers to the technical solution of the precise determination of the vertical acceleration even with inclined (within tolerances allowed) and tilting positions in the working position of the base (platform) the device to be positioned whereon, the latter putting the solution proposed into practice.

The solution can be used in navigational, piloting and marine navigational systems and devices, in transport vehicles stabilization systems and movement safety, for measuring vibrations and seismographic measurements, in medicine, etc.

### BACKGROUND OF THE INVENTION

The vector of acceleration a can be decomposed into 3 mutually perpendicular components, one of which a_{η} being directed horizontally (in the direction of the axis η). The other two components a_{ξ} and a_{ζ} are positioned in the horizontal plane and directed by axes ξ and ζ, accordingly.

Let supposedly the component a_{η} be the vertical acceleration and the component a_{ζ} lateral (transverse) acceleration.

While determining the vertical acceleration a_{η} the accelerations a_{ξ} and a_{ζ} are considered to be cross ones, and the axes the latter being directed along are considered to be the cross axes.

These accelerations are considered to be harmful since they cause the errors in measuring a_{η}.

For the autonomous determination of the vertical acceleration, in airless space including, presently only one method based on the determination of the seeming acceleration is known.

This method is realized, in particular, in the vertical acceleration accelerometer [1]. It should be noted that since in the device [1] use is made of the piezoelectric element serving as a sensitive pressure element; the device does not react upon the vertical acceleration but upon its derivative. So, particularly, with the constant acceleration at the output of this very element, there will be a zero signal.

The seeming acceleration is known to be an algebraic sum of projections of the components a_{η}, a_{ξ}, a_{ζ} on the axis of the vertical acceleration sensitive accelerometer. This axis of sensitivity is rigidly connected with the said accelerometer and is to be directed only vertically.

But, even if one places the said accelerometer on the known gyro platform to be stabilized in the horizontal plane, the said axis of sensitivity is practically always deviated from the vertical by some angle ν, however, it being insufficient. Even with the said insufficient deviation, considerably remarkable harmful effect is made by the cross accelerations. For example, in the inertial navigation systems even with constant flight altitude and with only one-minute inclination (1′) under the influence of the cross acceleration equal only to 1 m/c² there is a propagation error (due to the double integration) in determining flight altitude, the former being equal to 30 m or so for every minute of movement, which is not acceptable. With the cross acceleration 10 m/c², the said error is already equal to about 300 m for every minute of movement and so on.

The error caused by the cross accelerations is eliminated in the device for determining the horizontal acceleration devised and developed by the authors in the previous art [2]. But in the mentioned device the determination of the horizontal acceleration but not of the vertical one is made. Moreover, in the said device [2] any harmful effect is not prevented of the parameters spread of the sensitive elements (each pair of pressure sensors used jointly).

The aim of the technical solution proposed consists in increasing accuracy of determining the vertical acceleration and widening the field of the application of the said method, particularly, with the permissible tilting in the working position.

### SUMMARY OF THE INVENTION

To have the aim mentioned achieved there is proposed the method for determining the vertical acceleration including within the permissible tilting of the platform in the working position, the said acceleration determination being made whereon, the following stages:
the determination of the points in which the pressures created by the vertical acceleration (a_{η}) are considered to be different, and the ones created by the cross accelerations (a_{ξ} and a_{ζ}) acting in the horizontal plane are considered to be equal,
the determination of the pressures in the above mentioned points,
the determination of the vertical acceleration by the pressures difference in these very points.

As the points for determining pressure there have been chosen the points in which the columns lengths of the flowing medium acting on these points vertically are equal, and those acting along the cross-section axes (ξ and ζ), are equal (even with the permissible tilting in the working position).

Let us keep in mind for the further consideration that as an example the horizontal axis ξ is to be positioned in the plane passing through the vertical and transverse axes of the mobile object, through its lines parallel to these axes, in particular, and the horizontal axis ζ is to be positioned in the plane passing through the vertical and transverse axes of the mobile object, particularly, through its lines parallel to the said axes.

The device intended for implementing the method proposed consists of the miniature sealed vessels, pressure sensors and differential scheme switched in to the said pressure sensors, at the output of the said scheme the signal of the vertical acceleration is being read off.

The number of the vessels to be chosen can be different, for example, having two vessels one can obtain (two-vessel devices), and even one vessel can give one-vessel device. But for all that, for every two pressure sensors the two predominantly equal internal cavities filled with flowing medium are to be chosen.

The number of the pressure sensors to have been chosen is even, and in particular, the two pressure sensors connected with the vessels, with one vessel, in particular.

The vessels are fixed on the platform, mainly, on the mobile object body.

The said inner cavities can be applied when completely insulated from each other. In this case, they are filled with any flowing medium (liquid, gas or the mixture thereof), and as the pressure sensors use can be made of any previously known pressure sensors.

It is preferable that the pressure sensors be used with the sensitive elements of semiconductor type; the latter are known to have changes of specific resistance being under the pressure. Hereby, it is necessary to choose the pressure sensors with similar parameters of their sensitive elements (the two-vessel devices with two sensitive elements of pressure), which is known to cause definite difficulty.

To prevent and eliminate any harmful effect of the parameters spread of the two sensitive elements of pressure the inner cavities can be separated by one sensitive element of pressure in the form of the elastic diaphragm: solid (the two-vessel device with one sensitive element of pressure) or with holes.

When choosing a solid elastic diaphragm, the inner cavities are filled with liquid with gas (gas bubbles) and gas. When applying a solid diaphragm with the holes, both inner cavities are filled with any flowing medium (liquid, gas or mixture thereof) and in this case the two inner cavities, in fact, are positioned in one vessel (one-vessel device).

Lots of forms of each (from the two) inner cavity, the cone-shaped form, in particular, are possible. Under the cone-shaped form of the inner cavity we will mean such a form wherein some part of it looks like a cone-shaped surface.

The cross-section contours of the two inner cavities are asymmetrical, counter-oriented and have parallel straight lines, in particular, superposed in one straight line. These said straight lines, in particular, have been chosen to be perpendicular to the vertical axis of the mobile object.

To prevent and eliminate any harmful effect caused by the vertical accelerations a_{ξ} and a_{ζ} in the contour of the cross-section of each inner cavity there have been chosen the most distant (on horizontal axes ξ and ζ) points, they remaining as such (the most distant) within the permissible tilting in the working position. Such points remaining the most distant on the axis ξ are referred to as extreme and the remaining ones being the most distant on the axis ζ are referred to as lateral (transverse) points.

The said parallel straight lines (superposed in one straight line, in particular) are considered to have the extreme points and to be similarly positioned in the said inner cavities.

To provide the most accurate determination of the vertical acceleration a_{η} in the contour of the cross-section of one inner cavity there has been chosen the upper point, and in the contour of the cross-section of another inner cavity there has been chosen the lower point, both remaining as such (upper and lower) with the permissible tilting in the working position. In particular, these said points (upper and lower) are the tops of the above mentioned cones.

The points for determining pressure have been chosen similar to the ones positioned in the inner cavities on the said parallel straight lines (in particular, superposed in one straight line). That means that these very points are positioned at the same distances from the said upper points and at the same distances from the said lower points. In particular, the above mentioned distances up to the upper points have been chosen to be equal to the distances till the lower points.

Each contour mentioned has been chosen asymmetrical vertically, relative to the straight line of this contour, the line containing the said extreme points.

The mentioned counter-orientation of the asymmetrical contours of the cross-sections of the inner cavities is attained by the arrangement of the most distant, vertically, of the said upper and lower points of these contours on either side of the above said parallel straight lines, vertically, in particular, along the vertical axis of the mobile object.

While using the elastic diaphragm as a sensitive element, the said asymmetry and the counter-orientation have been achieved relative to this diaphragm.

The said contours are positioned in the plane passing through the mutually perpendicular axes of the above said platform, one of which being the vertical axis, particularly, through the lines of this platform which are parallel to these axes. Another axis of this kind has been chosen, in particular, and it is one of the horizontal axes (longitudinal and transverse) of the transport vehicle. The said plane is crossing the solid diaphragm chosen along the straight line. On either side of this line there are positioned the points in pairs (belonging to this line) to be acted upon horizontally by the columns of flowing medium of the equal length. Therefore, the said diaphragm looks like the unity of in pairs-positioned points of the pressures determination whose signals difference does not depend on the permissible tilting in the working position.

Horizontal linear vibrations, despite any choice of the sensitive elements (pressure), are not considered to have detrimental effect. Moreover, with angular vibrations harmful influence of the cross centripetal accelerations is eliminated since they are horizontally directed. In the two-vessel device with two sensitive elements for eliminating harmful influence of the vertical vibrations the vessels are to be positioned so that the points of pressure determination are to be situated as close as possible to each other, in particularly, the said parallel lines are to be contiguous to each other and be congruent.

In case use is made of the piezoelectric elements as sensitive elements of pressure, they are known to give off signals of the acceleration derivative (and not of the acceleration itself). In this case the power supply is not required. At the same time the signal of acceleration can be obtained by means of technical performance of signal integration of the said derivative.

In the two-vessel device with the solid diaphragm the volume of gas bubbles has been chosen not less than the volume of the fluid forced out by the most possible acceleration. In this device for eliminating any harmful influence of gas (gas bubbles) every inner cavity is provided with the accumulating chamber with heating, for example, by means of electrical current passing over the winding to be wound on the gas parts of the said chamber, wherein the gas bubbles accumulate. With that, the volume of the gas part of the accumulating chamber has been chosen not less than the volume of the fluid forced out by the most possible acceleration.

Each vessel can be provided with the screw screwed into the wall of the vessel having the thread of the same kind as the said screw, and the body of the screw is partly put into the inner cavity of the vessel. The presence of such screw enables it to perform adjustment (change) of the pressure in the vessel (when the said screw being screwed in, the pressure is increasing, and vice versa). That enables it to make a calibration, for example, nullification, of the output signal of the vertical acceleration device before starting applying it.

When using the elastic diaphragm (solid or with holes), as two pressure sensors use is made of the two condensers whose electrodes are electrically insolated from each other, the said diaphragm (common electrode for both condensers) and the walls of the above mentioned cavities positioned on either side of the said diaphragm. The said electrodes are switched into the differential scheme. In case the walls of the inner cavities are made of insulating material, then metal coating is applied on the walls, the former serving as the electrodes of the condensers (the same as with the elastic diaphragm).

The electric bridge, the magnetic amplifier with the differential scheme, the electric parameters difference scheme (active capacitance or inductive reactance, currents, voltage) can be used as a differential scheme (differential block).

The liquid to be chosen for filling in the inner cavities can be various, for example, silicone-shaped oil (the density thereof practically does not depend on the temperature within wide limits of its change), ligroin and etc.

For using the vertical acceleration device in the tilting position (for example, aircraft vehicle) in this case it is necessary to change the polarity of the output signal for the opposite one.

With tilting (by the angle ν) it is the projection of the vertical acceleration ≈≈a_{η} cos ν that is determined and not the vertical acceleration a_{η} itself.

It can be explained by the fact that with tilting the height of the column of the flowing medium decreases, it acting on the point of the pressure determination (on the elastic diaphragm). Thus, hereby, there appears the error Δa_{η} equal to Δa_{η}≈a_{η}−a_{η} cos ν=a_{η} (1−cos ν). With small angles ν (for which, with higher accuracy, it is possible to calculate cos ν=1) this very error can be ignored.

As the investigations carried by the authors show it is quite possible, with higher accuracy, to practically eliminate this very error with big angles of tilting (dozens graphs) as well. This is achieved by the choice of the most optimum form (shape) of the cross-section contour of the inner cavity of the vessel and by the position of the points of the pressure determination (the points of the diaphragm, in particular).

Thus, the invention has for an object to provide a technical solution containing the method (process) and the device for its implementation, both being the unity as a result of one common inventive idea and conception (the determination of the vertical acceleration).

### BRIEF DESCRIPTION OF THE INVENTION

The invention is explained and illustrated, by way of example, in the accompanying drawings, in which it is shown as follows:

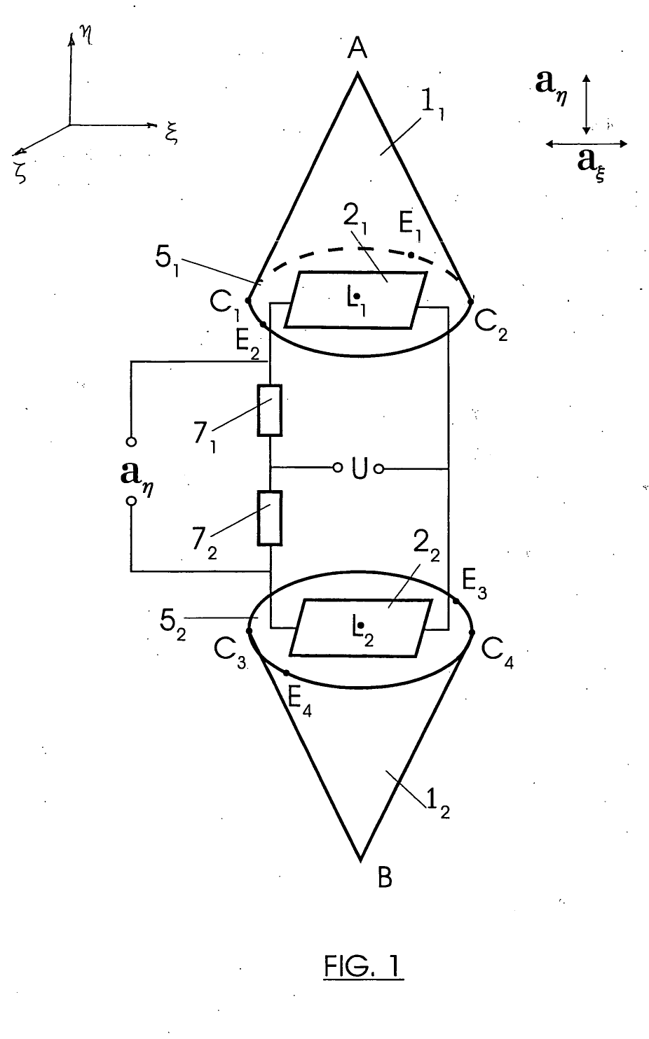

FIG. 1—the scheme of the two-vessel device for the determination of the vertical acceleration with two pressure sensors, each of them having its sensitive element.

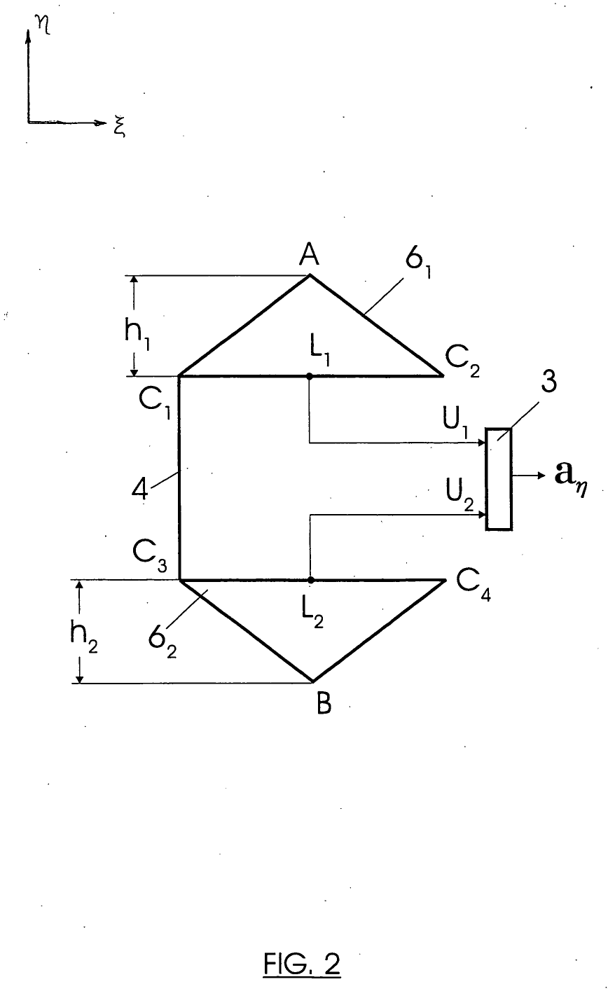

FIG. 2—the scheme of the contours of the cross-sections of the inner cavities of the two-vessel device for determining the vertical acceleration in the horizontal position;

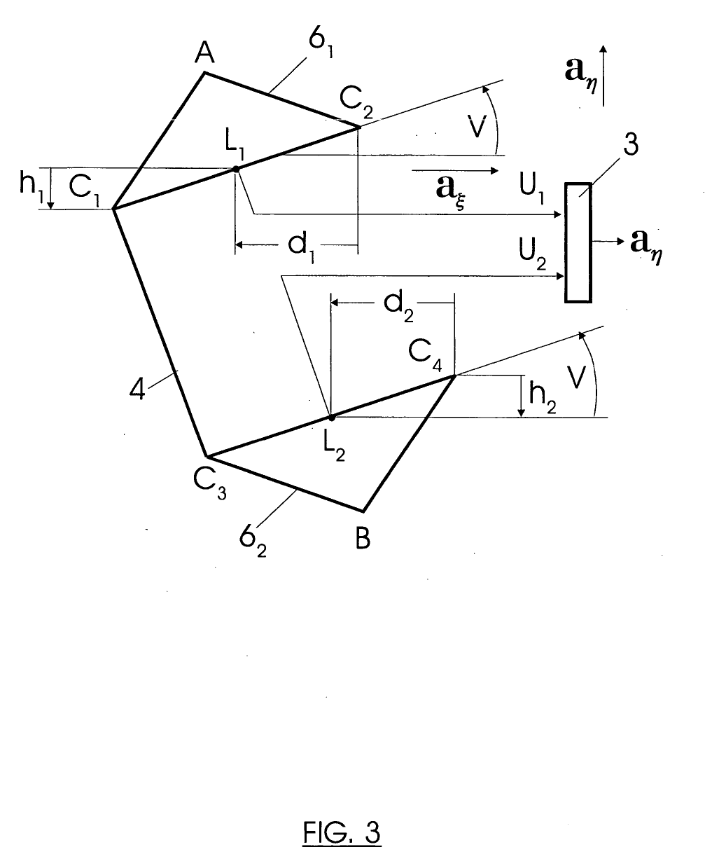

FIG. 3, 4—the schemes of the contours of the cross-sections of the inner cavities of the two-vessel device for determining the vertical acceleration in the tilting position;

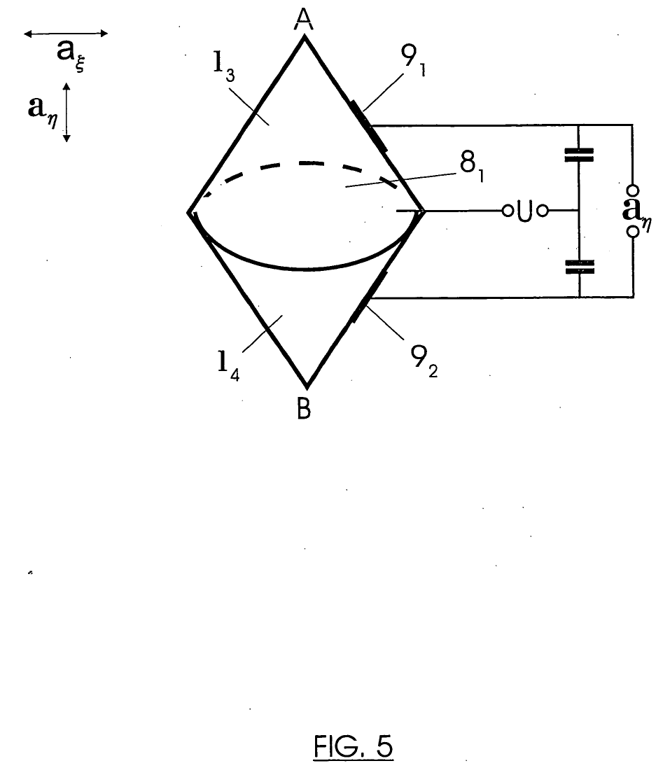

FIG. 5—the scheme of the two-vessel device for determining the vertical acceleration with the solid diaphragm;

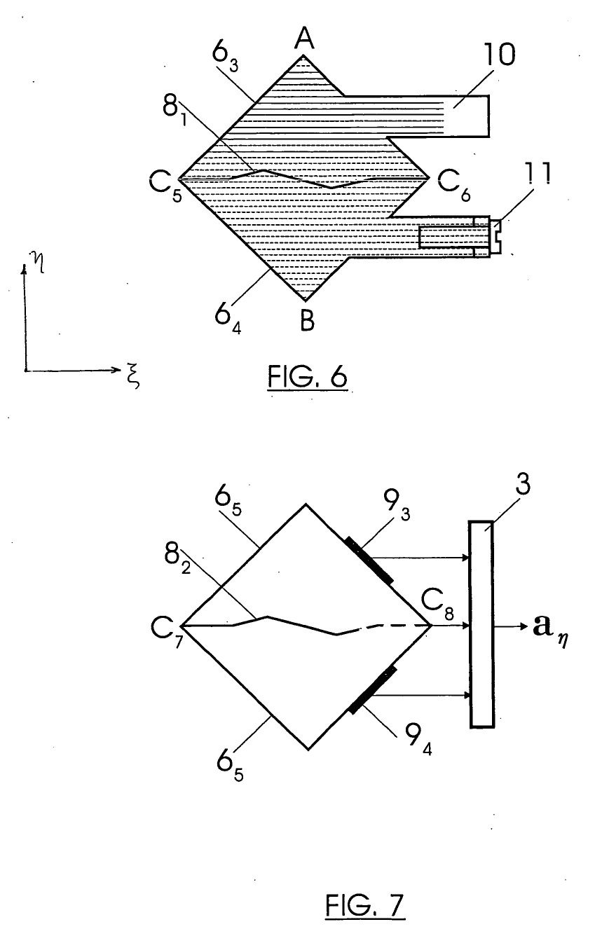

FIG. 6—the contours of the cross-sections of the inner cavities of the vessels with the solid diaphragm (with the accumulating chamber and the regulation screw);

FIG. 7—the inner cavities cross-section contour scheme of the one-vessel device for determining the vertical acceleration (with the elastic diaphragm having holes).

On the drawings there is no thickness of the vessels walls shown. In FIG. 1 there are sensitive elements of the pressure sensors, by way of example, shown in the form of rectangles. On the other drawings there are no pressure sensors (in particular, their sensitive elements) shown, but the points of determining pressure by these sensors are shown.

### DETAILED DESCRIPTION OF THE INVENTION

The method proposed for determining the vertical acceleration consists in the following:
determining the points, wherein the pressures created by the vertical acceleration are said to be different, whereas the ones created by the cross accelerations are said to be equal,
determining the pressures in the said points,
determining the vertical acceleration by the pressures difference in these points.

The points of determining the pressures have been chosen so that even with the permissible tilting in the working position the columns lengths of the flowing medium acting on the said points horizontally, are equal.

Constructively, the said method can be implemented through different ways. But, irrespective of that, in each of the devices for the implementation of the method proposed there have been chosen two inner cavities filled with the flowing medium for every two jointly connected pressure sensors.

Depending on the numbers of the vessels the numbers of the sensitive elements (in terms of pressure) and their type and the kind of the flowing medium there have been chosen the following, for example:
the two-vessel device D₁ with two sensitive elements of pressure (FIGS. 1,2,3,4), wherein each pressure sensor is said to have its sensitive element and as the flowing medium one can choose any flowing medium (liquid, gas and their mixture);
the two-vessel device D₂ with the sensitive element of pressure (FIGS. 5,6) in the form of the solid elastic diaphragm, and as the flowing medium there have been chosen the liquid with gas (gas bubbles) or gas;
the one-vessel device D₃ (FIG. 7) with the sensitive element in the form of the elastic diaphragm with the holes, and there has been chosen any flowing medium (liquid, gas or their mixture) as the flowing medium.

Let's consider the above mentioned devices in the following sequence D₁→D₂→D₃).

The device D₁ consists of the two sealed rigidly connected with each other, essentially similar, hollow vessels 1₁ and 1₂ (FIG. 1) filled with the flowing medium (liquid with the gas bubbles, in particular) as well as there are pressure sensors connected with the vessels, particularly, the two pressure sensors, with the sensitive elements (pressure) 2₁ and 2₂ switched to the differential scheme (differential block) 3 (FIGS. 2, 3, 4).

The vessels are non-congruently fixed (i.e. cross-section contours of their inner cavities are counter-oriented on base 4 (FIGS. 2, 3, 4) and the pressure sensors are fixed on side walls (the cone bases) 5₁ and 5₂ of the vessels 1₁ and 2₂ (FIG. 1).

As the base (platform) there may serve the body of the mobile object or the base stabilized in the horizontal plane or the inertial base (i.e. immobilized in the inertial space):

In FIG. 1 the characteristic points indicated (A and B; L₁ and L₂; C₁ and C₂; C₃ and C₄; E₁ and E₂; E₃ and E₄) belong to the contours of the cone-shaped inner cavities of the vessels, and the sensitive elements of the pressure sensors, for simplification, are relatively indicated by rectangles, in the centre of each there is the point shown in which the determination of the pressure by the given pressure sensor is being made.

On contours 6₁ and 6₂ of the cross-sections of the inner cavities of the vessels 1₁ and 1₂ (further—the vessels cross-sections) there have been chosen the characteristic points:

the points of determining pressure L₁ and L₂, the upper point A, the lower point B, the extreme points C₁ and C₂, C₃ and C₄ (i.e. the most distant along horizontal line from the points L₁ and L₂, correspondingly).

With permissible tilting (deviations) in respect of the vertical, these said points remain to be characteristic, i.e. the upper point A remains to be upper and the lower point B remains to be lower, and the extreme points C₁ and C₂, C₃ and C₄ remain the extreme ones. The lateral points E₁ and E₂, E₃ and E₄ with these inclinations remain lateral as well.

The permissible tilting remains as such with ν≦δ where ν is considered to be the angle of inclination from the vertical, δ is the maximum permissible angle of inclination from the vertical.

The points of determining pressure L₁ and L₂ are situated similarly in the similar inner cavities of the vessels, i.e. at the similar distances from the corresponding points of these cavities. Or otherwise, with congruent position of the inner cavities of the vessels (this may take place before fixing the vessels on the base) and supposed parallel moving of them till their complete superposing (which is possible as a result of the similarity of the inner cavities of the vessels) the points L₁ and L₂ (like congruent bases of the cone-shaped inner cavities of the vessels) are considered to match as well.

Moreover, the points L₁ and L₂ are similarly positioned only in the cone-shaped inner cavities of the vessels but also they are similarly positioned on the parallel straight lines containing, in particular, the extreme points (C₁C₂∥C₃C₄) i.e. C₁L₁=C₃L₂, C₂L₁=C₄L₂. It means that these points L₁ and L₂ are similarly positioned on the bases of the said inner cavities. In particular, there have been chosen C₁L₁=C₃L₂=C₂L₁=C₄L₂.

In the differential scheme (the differential block) 3 the signal of one pressure sensor is deduced from the signal of another sensor (particularly, from the signal of the sensitive element 2₁ there is deduced the signal of the sensitive element 2₂).

From the output of the differential scheme (differential block) 3 there is taken the signal of the vertical acceleration a_{η}.

As the differential scheme (the differential block) 3 use can be made of the electrical bridge, magnetic amplifier on the differential scheme, an electrical scheme of the electrical parameters difference (electrical voltages, currents, resistances, capacities or inductances)

In FIG. 1 as the differential scheme (for example) use is made of the electrical bridge consisting of 4 arms.

In the neighboring (adjacent) arms of the said bridge there are included sensitive elements (pressure) 2₁ and 2₂ and in other neighboring arms there are included, for example, resistors 7₁ and 7₂ (the ones with the equal electrical resistances being more preferable). The said bridge is powered by the electrical voltage U supplied through one of its diagonals, and there is taken the signal a_{η} from another diagonal of the said bridge.

With having similarly acting disturbances, for example, temperature changes, the resistance of the sensitive elements 2₁ and 2₂, as well as the resistance of resistors 7₁ and 7₂ are considered to change alike, and therefore, there is no error signal at the output of the electrical bridge in these cases.

The volume of the gas bubbles has been chosen to be not less than that of the liquid forced out through the most possible acceleration.

In FIGS. 1-6 there are the contours of the cross-sections of the inner cavities of the vessels in the form of triangles shown.

The contours of another form are also possible (it's more preferable for them to be alike), but they are to be (like inner cavities of the vessels) non-congruent, which causes the opportunity of determining the vertical acceleration. This non-congruency is archived by the asymmetry, along the vertical, of each of the cross-section contours 6₁ and 6₂ as well as their counter-orientation (along the vertical).

Under the asymmetry of each of the said contours (of each of the inner cavities of the vessels) one can mean its asymmetry in terms of the straight line containing the extreme points C₁ and C₂, C₃ and C₄ (or lateral points E₁ and E₂, E₃ and ₄), they remaining as such with the permissible tilting (for the ν<δ) in the working position.

Under the counter-orientation of the said contours (as well as the inner cavities of the vessels one means the disposition of the upper (A) and the lower (B) points (remaining as such with the permissible tilting in the working position) along the vertical, in particular, along the vertical axis of the mobile position) along the vertical, in particular, along the vertical axis of the mobile object, on either side of the straight lines containing the said extreme (or lateral) points.

The similar disposition of the points determining pressure L₁ and L₂ on the bases of the inner cavities of the vessels is said to eliminate any harmful effect of the cross (lateral) acceleration a_{ζ} (directed along the horizontal axis ξ perpendicular to the horizontal axis ξ), since these points are acted along the axis ζ by the columns of the flowing medium of the equal length even with tilting. The equality of these lengths is explained by the similarity of the inner cavities of the vessels made in the form of the rotund straight cones (with the bases being made in the form of circles). Due to the latter, the lateral points E₁ and E₂, E₃ and E₄ (positioned along the axis ζ) are considered to remain as such (lateral) with the permissible tilting in the working position.

As the pressure sensors, principally, use can be made of any of previously known ones (pressure sensors), tensoresistors, for example. Herewith, they can be positioned either on the inner or on the exterior part of the side walls 5₁ and 5₂ of the vessels 1₁ and 1₂, correspondingly.

In case use is made of the semiconductor tensoresistors (which are known to have changes of specific resistance under the influence of the pressure), they can be positioned on the inner side of the side walls.

In case use is made of the wire-wound or membranous (foil) tensoresistors, they can be positioned on the side walls made from the elastic diaphragms, and the latter becoming deformed (strained, extenders or shrunk). In this very case these tensoresistors can be positioned both on the exterior and on the inner sides of the side walls of the vessels.

Any pressure sensor gives out the signal of one value corresponding to the definite point of determining the pressure, although the many points of the sensitive element of the said sensor can react on the pressures. This very signal is also considered to correspond to the particular point of the said sensitive element (further the pressure signal point). Depending on the form of the sensitive element the centre of a circle or rectangle can serve as this very point.

It is obvious, that for determining the pressure in some point, for example, L₁ or L₂ it is necessary to superpose this very point with the pressure signal point.

Such superposing (of two points of different surfaces or objects) is like a famous task solved, in many cases, (for example, superposing of the source of light with the most acceptable point in space, while fitting of tooth prostheses, etc.).

An analytical solution of such superposing is confirmed by the experimental testing.

Similar disposition of the points for determining pressure L₁ and L₂ on the parallel straight lines containing, in particular, the extreme points mentioned is considered to eliminate any harmful effect of the horizontal acceleration a_{ξ} oriented along the horizontal axis ξ. The above can be explained by the following: the lengths of the horizontal columns of the flowing medium acting on the points for determining pressure L₁ and L₂ being changed with tilting still remain equal within the limits of the permissible tilting in the working position.

At the same time, with having the vertical acceleration at the output of the device D₁ there will appear the signal proportional to the said acceleration. In particular, with the horizontal position (FIG. 2) a_{η}=g (where g—the acceleration of free fall). Thus, if a_{η} is directed upwards then the height of the vertical column of the flowing medium h₁ (determined along the vertical) acting on the points for determining pressure L₁ turns out to be considerably bigger than the height of the vertical column of the flowing medium h₂, the latter acting on the point for determining pressure L₂ (FIG. 3).

That is why, in this case the signal u₁ coming to the differential block (differential scheme) 3 from the sensitive element 2₁ is expected to be considerably stronger than the signal u₂ coming to the same block from the sensitive element 2₂.

As a consequence, the difference Δu−u₁−u₂ is expected to be proportional to the acceleration a_{η}, whose signal is taken at the output of the differential block (differential scheme).

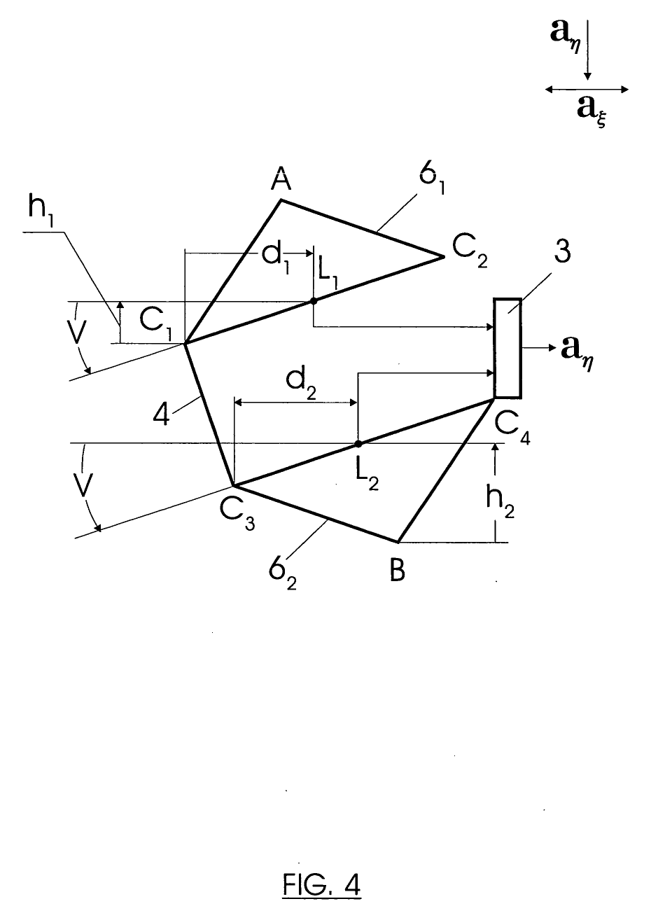

And vice versa, if a_{η} is directed downwards, a_{η} and at the same time |a_{η}|>g, then the height of the vertical column of the flowing medium h₂ acting on the point for determining pressure L₂ is expected to be considerably larger than that of the vertical column of the flowing medium h₁ acting on the point for determining pressure L₁ (FIG. 4). Thus, in this case the signal u₂ coming to the differential block (differential scheme) 3 from the sensitive element 22 will turn out to be considerably stronger than the signal u₁ coming to the same block. Due to the above the difference Δu=u₁−u₂ is also expected to be proportional to the acceleration a_{η}, this signal being taken at the output of the differential block (differential scheme).

Thus, in the differential (output) signal only the pressure signal is present, it being created by the vertical acceleration a_{η} and there are no signals created by any, in terms of sign, cross accelerations a_{ξ} and a_{ζ}.

Further, consideration is given to the theoretical substantiation of independence of the vertical acceleration determination from the cross accelerations influence.

For that the following symbols are introduced:

P₀—the pressure of filling the flowing medium to the vessels;

P₁—the pressure of the flowing medium in the point L₁;

P₂—the pressure of the flowing medium in the point L₂;

ρ—the density of the flowing medium

d₁ and d₂—the lengths of the horizontal columns of the flowing medium acting along the horizontal axis ξ on the points L₁ and L₂ (FIGS. 3, 4) correspondingly;

dₛ_{₁} and dₛ_{₂}—the lengths of the horizontal columns of the flowing medium acting along the horizontal axis ζ on the points L₁ and L₂, correspondingly;

h₁ and h₂—the heights of the vertical columns of the flowing medium acting along the vertical on the points L₁ and L₂ (FIGS. 2, 3, 4), correspondingly;

ΔP=P₁−P₂—the difference of pressures in the points L₁ and L₂ at the output of the differential scheme (differential block) 3.

In FIGS. 2, 3, 4 there are shown the schemes of the contours of the cross-sections of the inner cavities of the two-vessel device D₁, wherein each pressure sensor having its sensitive element.

In FIG. 2 there is shown the said scheme in the horizontal position with a_{ξ}=0. In the case with FIG. 2:
P₁=P₀+ρgh₁, P₂=P₀, (1)
ΔP=P₁−P₂=ρgh₁ (2)

It is seen that in the case with FIG. 2 the device D₁ determines g. This signal can be zeroed in.

In FIG. 3 there is shown the said scheme in the tilted position (by the angle ν) of the said contours with a_{ζ} acting to the right and a_{η}>0. Taking all that into consideration, as well as a_{ζ}≠0, we are having in conformity with the Euler's equation for FIG. 3:

$$\begin{matrix}\begin{matrix}{P}_{1} = {P}_{0} + {\int }_{{P}_{0}}^{{P}_{1}} ⅆ P \\ = {P}_{0} + ρ {\int }_{0}^{{h}_{1}} {a}_{η} ⅆ η + ρ {\int }_{0}^{{d}_{1}} {a}_{ξ} ⅆ ξ + ρ {\int }_{0}^{{d}_{{s}_{1}}} {a}_{ζ} \cdot ⅆ ζ\end{matrix} & ( 3 ) \\ {P}_{2} + {P}_{0} + {\int }_{{P}_{0}}^{{P}_{2}} ⅆ P = {P}_{0} + ρ {\int }_{0}^{{h}_{2}} {a}_{η} ⅆ η + ρ {\int }_{0}^{{d}_{2}} {a}_{ξ} ⅆ ξ + ρ {\int }_{0}^{{d}_{{s}_{2}}} {a}_{ζ} \cdot ⅆ ζ & ( 4 )\end{matrix}$$

From FIG. 3 it follows that
d₁=L₁C₂ cos ν, d₂=L₂C₄ cos ν (5)

But since the choice is made of L₁C₂=L₂C₄, then
d₁=d₂ (6)

Since the inner cavities of the vessels are similar and the points L₁ and L₂ are positioned in them similarly, then
dₛ_{₁}=dₛ_{₁} (7)

Taking into consideration (6) and (7), we have

$$\begin{matrix}ρ {\int }_{0}^{{d}_{1}} {a}_{ξ} ⅆ ξ = ρ {\int }_{0}^{{d}_{2}} {a}_{ξ} \cdot ⅆ ξ & ( 8 ) \\ ρ {\int }_{0}^{{d}_{{s}_{1}}} {a}_{ζ} \cdot ⅆ ζ = ρ {\int }_{0}^{{d}_{{s}_{2}}} {a}_{ζ} \cdot ⅆ ζ & ( 9 )\end{matrix}$$

Therefore, taking into consideration h₁>h₂, we have
ΔP=P₁−P₂=ρ∫a_{η}dη−ρ∫a_{η}dη>0 (10)

FIG. 4 shows the said scheme in the tilting position (by the angle ν) of the said contours with a_{ξ} acting to the left and with a_{η}<0 (a_{η}<0 is known to take place when going downwards to the ground with the acceleration |a_{η}|>g).

As it is seen from FIG. 4,
d₁=L₁C₁ cos ν, d₂=L₂C₃ cos ν (11)

But since the choice is made of L₁C₁=L₂C₃, then
d₁=d₂ (6)

Taking into consideration (6) and (7), h₁<h₂, we have

$$Δ P = {P}_{1} - {P}_{2} = ρ {\int }_{0}^{{h}_{4}} {a}_{η} ⅆ η - ρ {\int }_{0}^{{h}_{2}} {a}_{η} ⅆ η < 0 \qquad ( 12 )$$

Thus, in generally we have

$$Δ P = ρ {\int }_{0}^{{h}_{4}} {a}_{η} ⅆ η - ρ {\int }_{0}^{{h}_{2}} {a}_{η} ⅆ η > < 0 \qquad ( 13 )$$

This mathematical dependence (13) is said to be generalizing i.e. valid irrespective of the cross-sections shapes of the inner cavities of the vessels, the type of the pressure sensors to be used, the type of the flowing medium filling the vessels and irrespective of the kind of the forces acting hereby, either.

It should be stressed that when obtaining the dependence (13) the shapes of the inner cavities of the vessels are of no importance (this is also mentioned in Pascal's paradox) since the pressure in the still (relative to the vessels) flowing medium is determined only by the height (measured along the vertical) or/and by the length (measured along the horizontal) of the columns of the flowing medium acting on the points for determining the pressure L₁ and L₂. For example, one and the same height and/or length of the column of the flowing medium (horizontal) are said to be possible with infinite aggregate of various shapes of the cross-sections of the inner cavities of the vessels. At the same time, the values of h₁ and h₂, d₁ and d₂, dₛ_{₁} and dₛ_{₂} with different shapes of the said cross-sections can be different (they are determined by the distances from the points L₁ and L₂ up to the upper A and lower B points as well as up to the extreme and lateral points).

Special attention should be paid to the fact that Euler's law for hydrostatics is true only in the co-ordinates system, one of whose axis is the vertical and another two ones are horizontal and mutually perpendicular.

An output signal of the technical solution proposed is the residual signal expressed by the dependence (13).

Since in the said residual signal there are no, taken separately, pressure signals created by the gravity and the vertical inertia, then that means that in the technical solution proposed no distinguishing of the said forces takes place. From the physical point of view it is explained by the fact that both the signal of each pressure sensor (u₁ and u₂) and the output (residual) signal (ΔP) are determined by the weight force (and not only by the gravity).

The technical solution proposed is to provide only signals extraction of those pressures which are created by the weight force, (the latter being an algebraic sum of the gravity and the vertical inertia force).

However, distinguishing of the horizontal inertia force from the weight force is thought to be possible to solve. The said distinguishing, for example, is performed in inertial navigation systems. But, unlike the technical solution proposed it is performed in these systems only with strictly horizontal position of the base the accelerometers are positioned whereon. In the technical solution proposed this distinguishing is performed also in the tilting position of the base (within the permissible tilting).

Absence of the cross accelerations a_{ξ} and a_{ζ} in the residual signal (13) means that the axis of the sensitivity of the technical solution proposed is always directed along the vertical.

That also means that along these axes any harmful influence of the linear vibrations is considered to be eliminated, they being the part of the said cross-section accelerations. However, the linear vibrations along the vertical (along axis η) are the part of the vertical acceleration a_{η} and so the are submit to determination. In the device D₁ for eliminating any harmful influence of the difference of the vertical vibrations the vessels are so positioned that the points for determining pressure are positioned as close to each other as possible, particularly, the said parallel straight lines are to be congruently contiguous.

Thus, according the present technical solution the determination of the vertical acceleration is performed irrespective of the action of the cross-accelerations a_{ξ} and a_{ζ} (linear vibrations including) and, to a considerable degree, the angular vibrations as well.

With small values of the angles ν (for which cos ν=1 is considered to be very accurate) or with slight changes of these angles (for which cos ν=const is considered to be very accurate) one can ignore the changes of the heights of the vertical columns of the flowing medium acting on the points for determining pressure (L₁ and L₂) due to their rather insignificant values and it can be done with rather high accuracy, and one can consider the device D₁ to determine the value a_{η}.

Moreover, investigations of the authors show that there is the most optimal shape of the hollow cavity of the vessels and the only optimal pair of the points for determining pressure when it is possible to consider the device D₁ to determine pressure with rather higher accuracy a_{η} and with the values ν being tens of grades.

The sensitivity threshold of the device D₁ is said to be practically equal to zero as the pressure sensors are always kept ready for operation (there is no overcoming of the zone of non-sensitivity required) due to the action of the pressure delivering the flowing medium into the vessels.

Thus, for the device D₁ there is practically no limit in attaining accuracy meeting the highest possible standards.

There is no possibility to use zero sensitivity threshold equality in the accelerometer as it reacts in the tilting position upon the horizontal accelerations a_{ξ} and a_{ζ} even in the horizontal movement.

That means that in the device D₁ higher accuracy is attained compared with the one in the accelerometer, within the entire range of the values a_{η}.

Thus, the principle of the operation of the device D₁ to be proposed consists in determining the pressures difference in specification points with the sensitivity threshold equal to zero, wherein the pressures created by the cross accelerations (a_{ξ} and a_{ζ}) and other disturbing factors (the temperature changes and others) are considered to be equal to zero irrespective of the permissible (and acceptable) tilting, and the pressures created by the horizontal acceleration are considered to be different.

The device D₁ is intended for determining pressure signal in the points L₁ and L₂ by means of the pressure sensors, supplying them to the differential scheme (differential block) 3 and taking the signal an at the output of the said scheme (FIGS. 1,2,3,4).

In the scheme in FIG. 1, where the electrical bridge is being used as the differential scheme, with a_{η}=0 (the phenomenon of imponderability) the bridge is balanced and at its output the signal is equal to zero. With |a_{η}|>0 the changes of resistance of one of the sensitive elements 2₁ and 2₂ become considerably bigger than those of another of these elements, as a consequence, the bridge equilibrium is disturbed and the signal a_{η} is taken at its output.

In case use is made of piezoelectric elements as sensitive elements of pressure the signal of the derivative of acceleration is taken at the output pf the differential scheme. In this case it is required to have any power supply. Herewith, the acceleration can be obtained through signal integration of the said derivative.

The present operation of the device D₁ to be proposed, for the most part, is not considered to change in the tilting position of the mobile object—aircraft, since in the case described the lower point B becomes the upper one and the upper point A becomes the lower one, correspondingly. But with all that in mid, it is necessary to change the polarity of the output signal for the opposite.

In the device D₁ (FIGS. 1,2,3,4) any harmful effect of the cross accelerations (horizontal accelerations a_{ξ} and a_{ζ}) as well as other disturbing factors, particularly, temperature and vibrations (both linear and angular) is said to be eliminated.

However, for the above it is necessary to have pressure sensors with similar parameters of their sensitive elements.

The selection of the said sensors is a kind of problem.

Due to the spread of the parameters of sensitive elements of pressure sensors some error occurs. This error can be made very little in terms of the value (particularly, through zeroing). But to eliminate the said error at all below there is provided the device D₂ (FIG. 5. 6), wherein the said error is principally eliminated. Herewith, any harmful effect of linear as well as angular vibrations is said to be eliminated.

This purpose is achieved through substituting two sensitive elements reacting upon the pressure for one sensitive element (8₁) and through applying man-made (artificial) condensers as pressure sensors. These condensers are essentially the component part of the construction of the device for determining the vertical acceleration to be proposed.

The device D₂ (FIG. 5) consists of two sealed rigorously interconnected (fixed on one and the same basis), predominantly similar vessels 1₃ and 1₄ filled with the flowing medium (in particular, gas or liquid with gas bubbles).

The cone-shaped inner cavities of the vessels 1₃ and 1₄ are considered to have the common wall with the elastic diaphragm 8₁ which is the sensitive element reacting upon the pressure. The points of the sensitive element are located in each section of the said cavity, including those on the straight line, containing, in particular, the extreme points C₅ and C₆ (FIG. 6) remaining as such (the extreme ones) within the permissible tilting in the working position.

The diaphragm is electrically insulated from the walls of these cavities which are also electrically insulated from each other. In particular, the walls of the inner cavities of the vessels have been chosen to be made from insulating material with some metallic coatings (9₁ and 9₂), the latter being switched to the differential scheme (differential block). Every such metallic coating is said to play the role of an electrode (plate) of the artificially made condenser. Another (and common in this case) for both condensers of such type is the electrode that is an elastic diaphragm to be switched to the differential scheme (differential block) 3 as well.

In particular, in FIG. 5 use is made of the electric bridge as the differential scheme. The said artificially made condensers are to be switched to some of neighboring arms of the electric bridge and the condensers of constant, preferably similar electrical capacitance are to be switched to the other neighboring arms of the said bridge. The said bridge is supplied by the electrical voltage U through one diagonal, and the signal of the vertical acceleration a_{η} is taken from another diagonal.

In case of filling the inner cavities of the vessels with the liquid with the gas bubbles, the volume of the said bubbles has been chosen to be not less than the volume of the liquid forced out by the elastic diaphragm under the action of the maximum possible acceleration (to be more exact, the force causing the said acceleration).

The contours 6₃ and 6₄ (FIG. 6) of the cross-sections of the inner cavities of the vessels along the vertical are considered to 9 be asymmetrical and counter-oriented to each other (relative to the diaphragm).

Within the permissible tilting in the working position the upper (A) and the lower (B) points of the said contours are said to remain as such along the vertical (namely, upper and lower).

Under the asymmetry of the inner cavity of each vessel and each of the cones 6₃ and 6₄ of the section thereof we mean the asymmetry, in particular, relative to the straight line C₅C₆ along which there are positioned the points of the elastic diaphragm 8₁ (i.e. relative to the said diaphragm).

Counter-orientation of the said cavities and their contours 6₃ and 6₄ mean that the upper (A) and the lower (13) points are positioned on either side along the vertical (from the said straight line C₅C₆, and as a consequence, from the elastic diaphragm).

The above mentioned asymmetry and counter-orientation of the inner cavities of the vessels and their contours make them non-congruent (with them being parallel they don't superpose) which enable it to determine the vertical acceleration a_{η}.

The elastic diaphragm 8₁ is considered to be the system of a great number of the points thereon, positioned on either side of the diaphragm at the similar distance from the extreme points (C₅ and C₆). The points of each pair mentioned are said to be different, since they are acted upon by the flowing media from the different vessels. But from the geometrical point of view, taking rather insufficient thickness of the elastic diaphragm into account, these points can be considered to be superposed in one. The points of each pair of such kind are acted upon along the horizontal by the horizontal column of the flowing medium of similar length. So, the acceleration acting along the horizontal axes are not considered to cause any error signal (to cause any deflection of the elastic diaphragm), irrespective of the permissible tilting (while the extreme and lateral points remain as such).

Applying the differential scheme (particularly, the electrical bridge) is said to eliminate any harmful effect, the same is being done with the cross accelerations (including linear vibrations), as well as a number of other disturbing factors (the temperature changes, angular vibrations, and the like). It is explained by the fact that the said disturbing factors influence the elastic diaphragm in the same way from its both sides.

Under the influence of the vertical acceleration a_{η} the elastic diaphragm is deflected, which results in increasing the capacitance (electrical) of one pressure sensor (of one artificially made condenser), and decreasing another capacitance, and the signal of the vertical acceleration a_{η} is taken at the output of the differential scheme (differential block).

In case of applying the liquid with the bubbles, the latter are said to cause insufficient error resulted from the change of their concentration in different places (parts) of the vessels. This possible error is expected to be eliminated by the insulation of the gas bubbles from the liquid participating in acting on the elastic diaphragm.

Such isolation is based in the creation of the sufficient temperature drop, due to the latter the gas bubbles are concentrated in the warmest place (part). The said temperature drop is created by means of the winding wound on the said place (part), (in particularly, the central part of the inner cavity) and passing the current through it.

Moreover, for the complete isolation of the gas bubbles in each of the inner cavities provision is made (FIG. 6) for a miniature chamber accumulating the gas bubbles, the gas part 10 whereon there is wound the said winding with passing the current through the latter (the windings are not shown in FIG. 6). Due to that the gas will be accumulated in the said gas parts of the chambers in the warmest places. That is explained by the fact that every gas bubble is acted upon by the two anti-oriented forces: the force F caused by the temperature drop and buoyancy force Fₚ. With slight but sufficient temperature drop (F>Fₚ) there occurs travel of the gas bubbles to the warmest place (the gas part of the accumulating chamber). The volume of the said gas chamber is to be chosen not less than the least possible volume of the liquid forced out by the diaphragm with the greatest possible acceleration acting.

Like in any other device, in the device for determining the vertical acceleration the calibration of the output signal is required. For that, in particular each vessel is provided with the screw (for example, 11 in FIG. 6) with the thread in the vessel wall and the part of the screw body is to placed into the inner cavity of the said vessel (particularly, of the accumulating chamber). While screwing the said screw into the cavity, the pressure in the latter is increasing and the volume of the gas bubbles (gas) is decreasing.

Let us get to the description of the device D₃ (FIG. 7).

The application of the device, wherein a pair of insulated from each other sealed vessels (two-vessel devices) with one sensitive element (the elastic diaphragm) requires having gas bubbles (gas), which makes the said construction more complicated.

Therefore, the authors have chosen the technical solution consisting in replacing the pair of insulated sealed vessels by one sealed vessel (a one vessel device), and, naturally, with one sensitive element (the elastic diaphragm).

In such one-vessel device instead of a common wall of the two insulated one from another vessels there is provided an elastic diaphragm with holes (in FIG. 7 the said holes are shown by means of a dotted line), separating the inner cavities of the vessel.

The aggregate 8₂ of the pairs of the points for determining pressure of the elastic diaphragm are positioned in the triangular contours of the cross sections of the two inner cavities on the straight line containing, in particular, the extreme points C₇ and C₈, the latter remaining extreme, with the permissible tilting in the working position.

Herewith, in the contour 6₅ being common for the two cross-sections of the cone-shaped inner cavities of the vessel (a one-vessel device) consisting of two triangles, there are the same characteristic points, accordingly, (the upper, lower, extreme) as in a two-vessel device for determining the vertical acceleration.

And in the one-vessel device the diaphragm and metallic coating (9₃ and 9₄) are switched to the differential scheme (differential block) 3.

The horizontal acceleration is not considered to cause any deflection of the elastic diaphragm in the one-vessel device even in the tilting (permissible) position, on the contrary, the vertical acceleration is considered to cause the said deflection. That is explained by the fact that the points of the elastic diaphragm 8₂ are located, in particular, on the straight line containing the extreme points (C₇ and C₈) being the most distant along the horizontal.

Disturbing factors acting similarly (vibrations, temperature changes, etc.) on the elastic diaphragm (with the holes) from both sides is not considered to cause its deflection. At the same time, while acting a_{η} there on, it is deflected since it is acted upon by the pressures difference, and the volume of the flowing medium does not change herewith, and at the output of the difference block the signal a_{η} is taken.

In any of the devices (D₁, D₂, D₃) as the liquid there have been chosen silicone oil, ligroin or any other similar liquid.

According to an aspect of the technical solution proposed providing determining the vertical acceleration compared to the prior art irrespective of the type of disturbing factors there are the following remarkable distinguishing features:
determining the vertical acceleration according to the pressure difference in the points wherein the pressures created by the vertical acceleration are considered to be equal, but the ones created by the cross accelerations are considered to be different;
the equality of the lengths of the columns of the flowing medium even in the tilting position acting along the horizontal axes on the points for determining pressures;
the asymmetry of the contour of the cross sections of the inner cavities along the vertical, and counter-orientation (along the vertical);
presence of the most distant points along the horizontal axes, they remaining as such with the permissible tilting in the working position;
the cone-shaped form of the inner cavities;
presence of the accumulating chambers and their heating;
presence of regulation screws in the inner cavities;
the ratio of the volume of the gas part of the accumulating chamber and the volume of the liquid forced out through the maximum possible acceleration.

Investigations of the authors show that there exists the most optimal form (shape) of the inner cavity of the vessel, and the most optimal position of the points for determining pressures, in particular, the elastic diaphragms, as well.

The technical solution proposed compared with the prior art is said to have the following advantages:
the opportunity, unlike the accelerometer, of the accurate determination of the vertical acceleration even in the tilting position, and also the acceleration derivative while applying piezoelectric elements;
the opportunity for determining the vertical acceleration in the airless space;
the opportunity for determining the vertical acceleration in the upside down position (however, herewith, it is required that the polarity of the output signal be changed for the opposite);
the opportunity through integration for determining the vertical speed as well as the flight altitude and also the depth of submergence;
having arranged the vessels of the device for determining the vertical acceleration in the vertical plane at 90° and by having fixed them in the said position, we will obtain the device for determining the horizontal acceleration on the axis chosen. Herewith, the device for determining the said acceleration is expected to have the same merits as the device for determining the vertical acceleration but with reference to determining the acceleration along the horizontal axis chosen;
in the proposed technical solutions for determining the accelerations any harmful influence (effect) of the disturbing factors is eliminated, particularly, of the cross-section accelerations, vibrations, temperature changes even in the tilting position.

Presence of the proposed technical solution (determining the horizontal and vertical accelerations) enables it to eliminate sufficient drawbacks and disadvantages of the devices for determining the vertical, navigation-piloting parameters, location as well as the devices of stabilizing movement of the transportation vehicles. The devices invented by the authors on the basis of the technical solutions mentioned are considered to be considerably more accurate, simpler, cheaper, lighter and more compact compared with the prior art. It is in these devices that there is no need of the horizontal and azimuth stabilization. Therefore, they can be fixed directly on the body of the mobile object (without applying gyro platforms).

### NOTES

1. One should keep in mid that in the technical solution proposed the determination is made of the absolute vertical acceleration, namely, created by the gravity and the vertical force of inertia
2. For amplifying signals use can be made of the amplifiers.
3. In case of necessity an alternating current can be transformed into direct ones and vice versa.
4. Our request is to name our intentions to be proposed by us as below: “Naumov, the solution for determining the vertical acceleration”, “Naumov, a vertical acceleration device”
5. Because of the old age of Mr. M. Naumov (born in 1926) we are asking you to reduce the terms of the expertise of the patent application for the invention proposed.

We claim:

1. The method for determining the vertical acceleration comprising the following steps:
determining the points having the pressures wherein, created by the vertical acceleration, they being different, and those created by the cross accelerations being equal,
determining the pressures in the said points,
determining the vertical acceleration in terms the pressures difference in the said points.

2. The method as set forth in claim 1, wherein the points for determining having been chosen such that even with permissible tilting in the working position the lengths of the columns of the flowing medium acting on the said points along the vertical considered being different, and the ones acting along the cross-section axes considered being equal.

3. The device for determining the vertical acceleration comprising:
two sealed vessels fixed on the basis (platform), particularly, on the said body of the mobile object containing two, predominantly similar cavities filled with flowing medium, the cross-sections thereof, along the vertical, being asymmetrical, being counter-oriented, having parallel straight lines, particularly, superposed into one straight line passing through the most distant, along the horizontal, points,
two connected with the vessels pressure sensors having the sensitive elements of pressure, on particular, one sensitive element being in form of the elastic diaphragm, the points for determining the pressure thereof being chosen similarly positioned on the said parallel lines situated similarly in the said cavities, in particular, on the said superposed straight line,
differential scheme switched to the pressure sensors, at the output whereof the signal of the vertical acceleration being taken.

4. The device as set forth in claim 3, wherein the inner cavities being chosen in the form of the circular straight cones.

5. The device as set forth in claim 4, wherein in the contour of the cross-section of one of the inner cavities the upper point being chose, and in the cross-section of another inner cavity the lower point being chosen, both remaining as such with the permissible tilting in the working position.

6. The device as set forth in claim 5, wherein the contour of the cross-section of each inner cavity being chosen to be asymmetrical along the vertical relative to the straight line of the said contour, containing, along the horizontal, the most distant points.

7. the device as set forth in claim 6, wherein the said counter-orientation being essential due to the position of the most distant upper and lower points mentioned of the said contours on either side of the said parallel straight lines along the vertical, in particular, along the vertical axis of the mobile object.

8. The device as set forth in claim 7, wherein the said inner cavities being separated by the elastic diaphragm, which being switched, as well as the walls of the said cavities electrically insulated from each other being located on either side of the former to the differential scheme.

9. The device as set forth in claim 8, wherein as the flowing medium the liquid with gas bubbles being chosen.

10. The device as set forth in claim 9, wherein each vessel being provided with the screw with the thread in the wall of the vessel and the body of the said screw being partly put in the inner cavity of the said vessel.

11. The device as set forth in claim 9, wherein the accumulating chamber with heating being introduced into the inner cavity, for example, by means of electrical current passing through the winding wound on the gas part of the said chamber wherein the said gas bubbles being accumulated

12. The device for determining the vertical acceleration comprising:
a sealed vessel fixed on the basis (platform), in particularly, on the body of the mobile object, containing two flowing medium—filled predominantly similar inner cavities the cross-sections contours thereof along the vertical being asymmetrical and counter-oriented,
two vessel-connected pressure sensors having the sensitive element in the form of the elastic diaphragm made with the holes, containing the most distant, along the horizontal, points,
differential scheme switched to the pressure sensors, at the output thereof the signal of the vertical acceleration being taken.

13. The device as set forth in claim 12, wherein the said inner cavities being used in the form of the circular straight cones.

14. The device as set forth in claim 13, wherein in the contour of the cross-section of one inner cavity the upper point being chosen, and in the contour of the cross-section of another inner cavity the lower point being chosen, both remaining as such with the permissible tilting in the working position.

15. The device as set forth in claim 14, wherein the contour of the cross-section of each inner cavity being essentially asymmetrical vertically relative to the said diaphragm with the holes.

16. The device as set forth in claim 15, wherein the said counter-orientation being essential due to the position of the said most distant upper and lower points of these contours on either side of the said diaphragm along the vertical, particularly, along the vertical axis of the mobile object.

17. The device as set forth in claim 16, wherein as the pressure sensors use being made of condensers the electrodes thereof being electrical insulated from each other diaphragm mentioned, which separating the said inner cavities, and the walls of the said cavities, which being positioned on either side of it.

18. The device as set forth in claim 17, wherein the said electrodes being switched to the differential scheme.
